(19) United States
(12) Patent Application Publication
(10) Pub. No.: US 2001/0009113 A1
(43) Pub. Date: Jul. 26, 2001

(54) Apparatus for monitoring particulate materials

(76) Inventor: Ole Charles Hansen, Subiaco (AU)

Correspondence Address: Carol W. Burton, Esq., Suite 1500, 1200 17th Street, Denver, CO, 80202, US

(21) Appl. No.: 09/759,995

(22) Filed: Jan. 12, 2001

(30) Foreign Application Priority Data
Jan. 13, 2000 (AU) PQ5077

(51) Int. Cl. G01F 1/00

(52) U.S. Cl. 73/861

(57) ABSTRACT

An apparatus for monitoring a particulate material such as cotton is disclosed, in which a plurality of emitter-receiver pairs are arranged in a spaced apart manner about a passageway to monitor material flowing through said passageway, and a controller activates each emitter-receiver pair in sequence and obtains a signal from the receiver in that pair only, the controller keeps in an associated memory a cumulative count of the signals from each receiver, and calculates from the cumulative counts an estimated total quantity of material passing between the emitter-receiver pairs. The controller also maintains a weighting for each sensor in calculating the quantity of material flowing through said passageway, and compensate for one or more emitter-receiver pairs become blocked.

### FIELD OF THE INVENTION

This invention relates to an apparatus for monitoring particulate materials passing through an area. The invention is particularly well suited to monitoring cotton yield during harvesting, however the invention is also applicable in other monitoring applications.

### BACKGROUND ART

Apparatus for monitoring particulate materials are used In a variety of applications, from monitoring now rates and yields to, volume and quantity measurements. One example of the latter is described in U.S. Pat. No. 4,743,760 that describes an apparatus for metering flowable particulates for the purposes of providing a constant quantity of particulates. Such devices are commonly used when packaging particulate products such as pharmaceutical tablets into containers for sale. The apparatus described In U.S. Pat. No. 4,743,760 utilises a two dimensional array of emitters and receivers that are activated sequentially in pairs to avoid crosstalk between adjacent pairs. The apparatus is intended for use in metering pharmaceutical tablets moving past the emitters and receivers at a uniform velocity and thus a simple quantity calculation procedure is all that is needed.

Another application of these apparatus is measuring the yield of cotton as it is being harvested. The nature of cotton gives rise to particular problems, however. In contrast to solid, opaque objects such as tablets and pellets, harvested cotton has an opaque seed surrounded by a ball of cotton strands. A light beam, for example, striking a seed will be blocked fully whilst a light beam striking the cotton strands will be only partially attenuated. This gives rise to a problem in interpreting meaningful information from the signal received by the sensors. To date, yield monitors for cotton have typically used analog sensors, whereby the attenuation of the light beam is taken to be an indication of the quantity of cotton the light has passed through.

A further problem with harvested cotton is the waxy nature of the cotton, which has a tendency to leave deposits on surfaces the cotton comes into contact with. These waxy deposits attenuate the light from the emitters, which can lead to incorrect readings, or at least decreased sensitivity of the yield monitor.

An example of a cotton yield monitor is described in U.S. Pat. No. 5,920,018 that uses five LEDs and five receivers positioned on opposite sides of a passageway. The LEDs are energised simultaneously to generate signals at the receivers. The signals from the receivers are analog signals which are used to determine the quantity of material flowing through the passageway. To achieve reasonable results, this system requires that the signal from each sensor be compared with a base line signal generated where no material is flowing through the passageway. The level of attenuation or the signal at each sensor is taken to be an indication of the amount of material flowing through the passageway. However, the accumulation of dirt within the passageway from the cotton and the possibility of light scattering as it passes through the cotton reduces the accuracy of such a system. Since all of the LEDs are energised simultaneously, light from one of the LEDs can scatter and be received by the nine of the other sensors.

### DISCLOSURE OF THE INVENTION

Throughout the specification, unless the context requires otherwise, the word ‘comprise’ or variations such as ‘comprises’ or ‘comprising’, will be understood to imply the inclusion of a stated integer or group of integers but not the exclusion of any other integer or group of integers.

In accordance with one aspect of this invention, there is provided an apparatus for monitoring a particulate material, comprising:

a plurality of emitter-receiver pairs arranged in a spaced apart manner;

control means and associated memory, arranged to activate each emitter-receiver pair in sequence and obtain a signal from the receiver in that pair only, to keep in said associated memory a cumulative count of the signals from each receiver, and calculate from the cumulative units an estimated total quantity of material passing between the emitter-receiver pairs.

Preferably, said control means Is further arranged to compare the signal received from each receiver with a threshold value, to determine whether the signal represents a hit or a miss.

Preferably, said control means keep a cumulative count of signals representing hits from each receiver.

Preferably, said control means keeps a cumulative count of signals representing misses from each receiver

Preferably, said control means is arranged to indicate a fault condition for an transmitter-receiver pair if the signals from said receiver generate more than a predetermined number of consecutive misses.

Preferably, said control means is arranged to disregard the cumulative count for an emitter-receiver pair in calculating an estimated total quantity of material passing between the emitter-receiver pairs if a fault condition is indicated for that emitter-receiver pair, said control means being arranged to calculate the estimated total quantity of material from the cumulative counts of the remaining emitter-receiver pairs.

Preferably, said control means stores in said associated memory calibration information including a relative weighting of each emitter-receiver pair and a conversion ratio of hits or misses to a quantity of material, said control means utilising the calibration information when calculating the estimated total quantity of material from the cumulative counts.

Preferably, said control means stores in said associated memory characterization data relating to the material flowing through the passageway, the control means arranged to be responsive to the characterisation information, the signals received from the emitter-receiver pairs and the cumulative counts to calculate an estimated total quantity of material flowing through the passageway.

Preferably, said control means performs an analog to digital conversion of the signal from each emitter-receiver pair and stores said digital conversion in said associated memory, said control means further arranged to analyse said stored digital conversions to determine whether there has been an average decrease in the signal strength, and to lower said threshold value if the average decrease in the signal strength exceeds a predetermined value.

Preferably, said control means is arranged to indicate a blockage warning if the threshold value is lowered to a prescribed value.

Preferably, said control means performs an analog to digital conversion of the signal from each emitter-receiver pair and stores said digital conversion in said associated memory, said control means further arranged to analyse said stored digital conversions to determine whether there has been an average decrease in the signal strength, and to increase the power to said emitters if the average decrease in the signal strength exceeds a predetermined value.

Preferably, said control means is arranged to indicate a blockage warning if the power to the emitters is increased to a prescribed value.

Preferably, the emitter-receiver pairs are provided about a passageway so as to monitor material passing through said passageway.

Preferably, tho apparatus is provided in a housing having openings for the emitters or receivers, the housing including a panel formed of a material transparent to the signal produced by the emitters, the panel protruding from a face of the housing by an amount corresponding to a wall thickness of the passageway to produce a substantially smooth inner surface in the passageway.

Preferably, the housing includes at least one channel arranged to receive permanent magnets therein to secure the housing to the passageway wall.

Preferably, the emitter-receiver pairs are arranged in two substantially perpendicular lines.

Preferably, the lines are spaced apart so as to lie in two parallel planes.

### BRIEF DESCRIPTION OF THE DRAWINGS

Two embodiments of this invention will now be described with reference to the accompanying drawing in which:

FIG. 1 is a block diagram of the apparatus for monitoring particulate materials in accordance with a first embodiment of the invention;

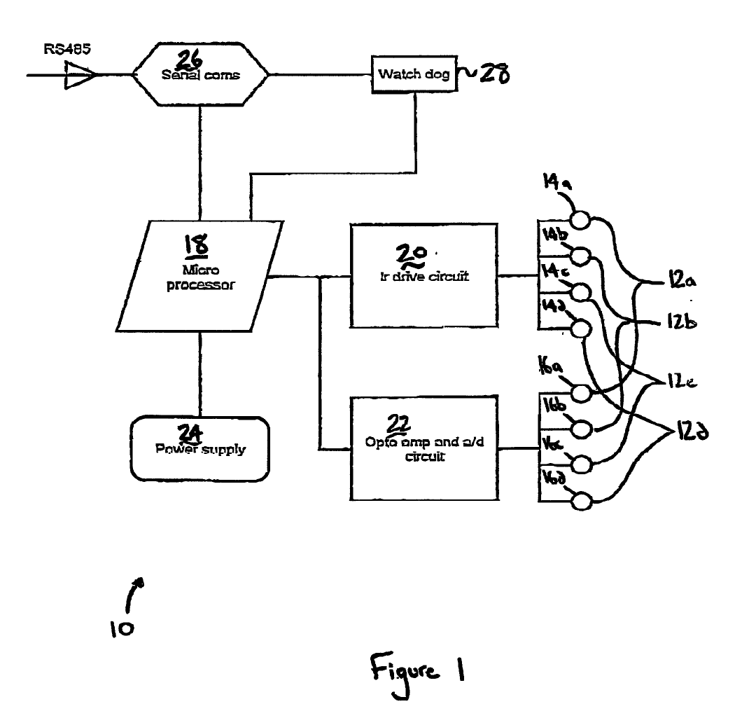

FIG. 2 shows four emitter-receiver pairs used in the apparatus shown in FIG. 1;

FIG. 3 is side view of a housing in which the apparatus shown in FIG. 1 is received;

FIG. 4 is a flow chart of the operation of the microprocessor used in the apparatus shown in FIG. 1; and

FIG. 5 shows eight pairs of emitter-receivers used in the apparatus for monitoring particulate materials according to a second embodiment of the invention.

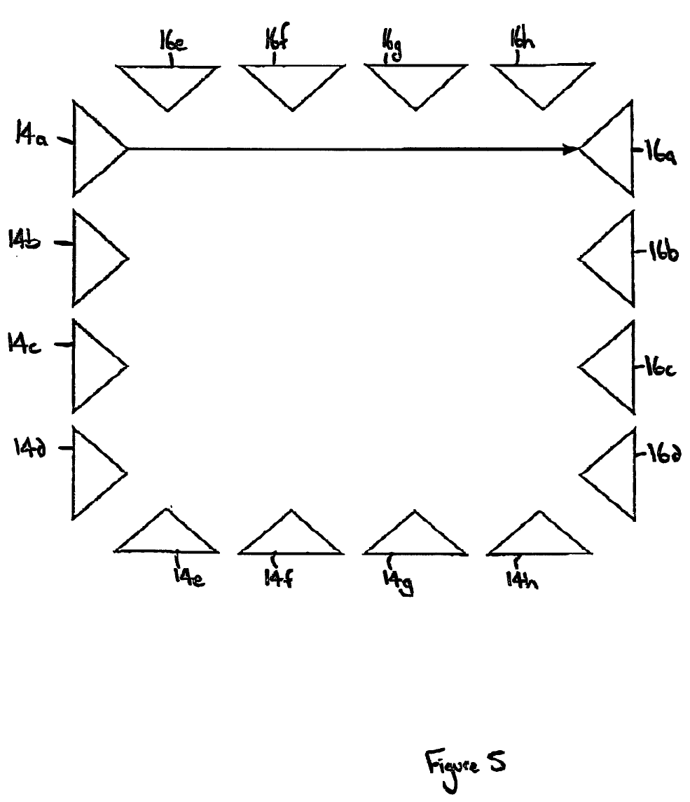

### BEST MODE(S) FOR CARRYING OUT THE INVENTION

The embodiments are directed towards apparatus for monitoring cotton yield. However, it should be appreciated that the invention can be applied to monitoring other forms of particulate material, not simply cotton.

The first embodiment is directed towards an apparatus 10 for monitoring particulate material, in this case cotton. The apparatus 10 comprises four emitter-receiver pairs 12a-12d, composed of infra-red LEDs 14a-14d and Infra-red sensors 16a-16d, respectively.

The apparatus 10 further comprises a control means in the form of a microprocessor and associated memory 18 that is connected to the infra-red LEDs 14a-14d via a drive circuit 20. and to the infra-red sensors 16a-16d via an optoelectronic amplifier and analog to digital conversion circuit 22.

A power supply 24 provides power to the apparatus 10.

The microprocessor 18 is in communication with a serial communications interface 26 for communication with external devices. In the embodiment, the serial communications interface 26 utilises the RS-485 protocol standard. A watchdog circuit 28 is in communication with the microprocessor 18 and the communications interface 26. The watchdog circuit 28 receives a signal from the microprocessor 18 at a known interval. If the watchdog circuit 28 does not receive the signal for a prescribed time, it resets the microprocessor 18.

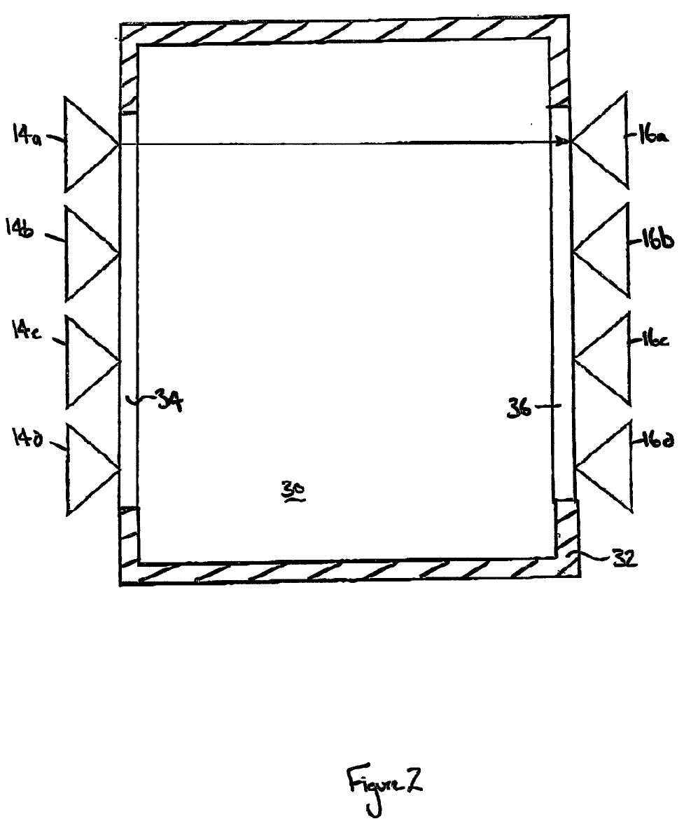

FIG. 2 shows the infra-red LEDs 14a-14d and the infra-red sensors 16a-16d positioned on opposite sides of a passageway 30 defined by a wall 32. The wall 32 has apertures 34 and 36 provided on opposite sides thereof. The infrared LEDs 14a-14d are positioned adjacent the aperture 34 and the infra-red sensors 16a-16d are positioned adjacent the aperture 36. Looking at FIG. 2, the cotton would flow along the passageway from above the page to below the page.

The microprocessor 18 activates each of the infra-red LEDs 14a-14d in turn in a time division multiplexed manner. When one of the infra-red LEDs 14a-14d is active, the microprocessor 18 reads a signal from the corresponding infra-red sensor 16a-16d only, via the optoelectronic amplifier and analog to digital conversion circuit 22. Eight bit analog to digital conversion is performed on the analog signal produced by the infra-red sensors 16a-16d.

There is no cross talk between any of the emitter-receiver pairs 12a-12d. When, for example, the infra-red LED 14a is active, the microprocessor 18 reads a signal from the infra-red sensor 16a only. In the embodiment, the time division multiplexing is performed at a frequency of 1000 Hz. In other embodiments, other frequencies could be used according to the size of the material being sensed and its velocity as it travels past the apparatus.

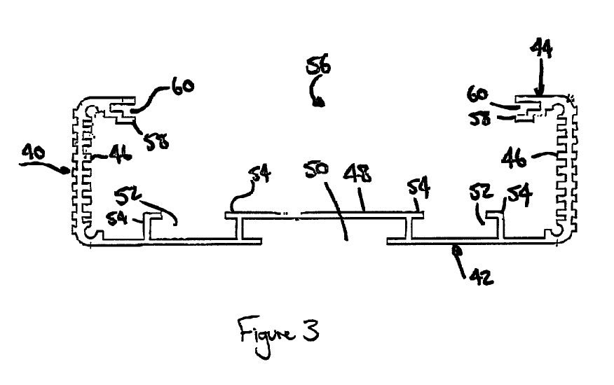

FIG. 3 shows a housing 40 in which the microprocessor 18 and associated circuitry arc provided. The housing 40 comprises a front face 42, a rear face 44 and sides 46. The front face 42 has recessed portion 18 defining a central aperture 50 therein. The recessed portion 48 has apertures therein (not shown) adjacent which either infra-red emitters 14a-14d or infra-red sensors 16a-16d are mounted.

Two channels 52 are defined to either side of the recessed portion 48 by flanges 54. The channels 52 are shaped and configured to allow permanent magnets (not shown) to be slidingly received therein. The permanent magnets are used to secure the housing 40 to the wall 32 of the passageway 30 in a releasable manner. The permanent magnets arc strong enough to attach to the wall 32 through the front face 42 of the housing 40.

The rear face 44 of the housing 40 includes an open portion 56. Further flanges 58 at each side of the open portion 66 define recesses 60 in which a printed circuit board (not shown) containing the microprocessor 18, serial communications interface 26 and the drive circuit 20 can be slidably received. A display (also not shown) is mounted on the reverse side of the printed circuit board to protrude outwardly from the open portion 50.

A glass panel (not shown) is slidably received within the aperture 50 of the front face. The glass panel protrudes beyond the front face 42 a distance commensurate with the thickness of the wall 32 that defines the passageway 30. The glass panel is shaped to be approximately the same size as the apertures 34 and 36 in the wall 32 of the passageway 30. This provides a convenient mechanism to align the housing 40 relative the passageway 30. It also provides a relatively smooth inner surface on the passageway 30 to reduce the accumulation of waxy debris from the cotton as it flows past the apertures 34 and 36.

In the embodiment, the drive circuit 20 and the infra-red LEDs 14a-14d are provided in one housing 40 along with the microprocessor 18 and associated circuitry The infra-red sensors 16a-16d and the optoelectronic amplifier and analog to digital conversion circuit 22 is provided in a further housing of the same form as the housing 40. The two housings are attached to opposite sides of the passageway 30 and are connected by a suitable cable.

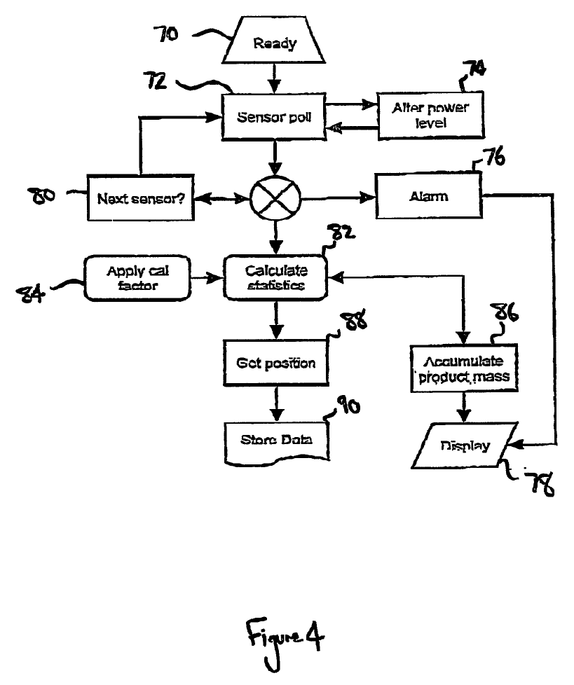

The operation of the apparatus 10 will now be described with reference to the flowchart shown in FIG. 4. Firstly, the apparatus is calibrated. This is best achieved by passing a known quantity of material through the passageway 30. Whilst in calibration mode, the microprocessor 18 simply records the number of misses (described below) from each of the infra-red sensors 16a-16d. Separate cumulative counts are kept for each of the sensors 16a-16d. Once all of the material has passed through the passageway 30. The operator enters the amount of material used in the calibration. From this amount, the microprocessor 18 calculates a calibration figure by dividing the entered amount by the total number of misses recorded by all of the sensors 16a-16d (called the ‘miss-to-mass ratio’), which is stored in the associated memory.

Further, the microprocessor 18 compares the number of misses recorded for each of the sensors 16a-16d and calculates their relative weighting. The relative weighting of each sensor is calculated as the cumulative count for that sensor divided by the sum of the cumulative counts for all of the sensors 16a-16d. The relative weighting values are stored In the associated memory. Once calibration is complete, the apparatus 10 is then ready For use.

When an operator wishes the apparatus 10 to monitor cotton flowing through the passageway 30, the operator initialises the apparatus, shown in FIG. 4 at step 70. The microprocessor 18 resets the cumulative counts for each of the sensors 16a-16d to zero and resets other information, such as alarms and power levels, which are described hereafter.

Next, the microprocessor 18 commences a sensor poll shown in FIG. 4 at step 72. Initially, the infra-red LED 14a is energised for a preset time at a power level corresponding to that stored by the microprocessor 18 using the drive circuit 20, Whilst the infra-red LED 14a is energised, the microprocessor 18 obtains an eight bit data signal from the optoelectronic amplifier and analog to digital conversion circuit 22 corresponding to the signal received by the sensor 16a from the infrared LED 14a. Any signals produced by the sensors 16b-16d are ignored.

The data value received from the microprocessor 18 is compared with a threshold data value. If the data value exceeds or equals the threshold data value, the signal received by the sensor 16a is considered sufficient to constitute a hit, otherwise the signal is considered to be a miss if the signal is considered a miss the cumulative count for the emitter-receiver pair 12a is increased by 1.

At step 74, the microprocessor 18 compares the data value with previously stored data values from the emitter-receiver pair 12a. By taking averages of the data values over time, the microprocessor 18 establishes whether the average power level received by the sensor 16a is decreasing. If this is the case, it is likely because of the accumulation of wax and other dirt in the passageway 30. To compensate for this, the microprocessor 18 increases its stored value of transmit power for the infra-red LED 14a.

Next, the microprocessor 18 determines whether an alarm condition is indicated, at step 76. A sensor failure alarm is indicated if the data value from the sensor indicates a miss and the preceding five data values from that sensor have all indicated a miss. This is because it is unlikely that the light from LED 14a to the sensor 16a would be interrupted by a cotton seed on six consecutive occasions.

Further, if the power level at step 74 has been adjusted above a prescribed level, a sensor blockage alarm is raised. The alarms are displayed on the display (not shown) at step 78.

If no alarms are indicated, or once the alarms have been displayed at step 78, the next sensor is polled at step 80.

Once all of the sensors have been polled in turn, the microprocessor 14 performs statistical calculations at step 82. The statistics are calculated at 82 by reference to calibration information, shown in FIG. 4 at 84. To calculate an approximate quantity of material that has passed through the passageway 30, the cumulative counts of the sensors are totalled. If any of the sensors have an alarm condition from 76, the cumulative count for that sensor is not used in calculating the total. The total is then multiplied by the miss-to-mass ratio determined by calibration described above.

If any of the sensors have an alarm condition, the resulting figure is then divided by (1-relative weighting of alarmed sensor/s). For example, if one of the sensors had an alarm condition and that had a relative weighting of 0.18, the resulting figure would be divided by 0.82 to compensate for the failure of that sensor.

Other statistics such as the mass within the last second can also bee calculated in a relatively simple manner. Once the desired statistics have been calculated, the results are stored and accumulated at 86 and then displayed at 78.

If the apparatus is connected to a GPS or other positioning system, the current position is retrieved at 88. Instantaneous data, such as the material passing through in the last second is then stored along with the position at 90. The device then returns to conducting the sensor poll at 72.

The apparatus of the embodiment provides a cotton yield monitor that overcomes many of the problems associated with analog systems. Further, flexibility is provided by adjustment to the power used by each infra-red LED to compensate for dirt and wax accumulation as the device is operated. The time division multiplexing of each emitter-receiver pair reduces inaccuracy from crosstalk and scattering. Further, the estimation system used is relatively robust and allows for one or more of the sensors to block and still be operable.

The second embodiment is also directed towards an apparatus 100 for monitoring the flow rate of cotton through a passageway. The apparatus 100 is of the same general form as the apparatus 10 described in relation to the first embodiment, with like reference numerals denoting like parts to those in the first embodiment with 100 added thereto. The difference between the apparatus 100 and the apparatus 10 of the first embodiment is that the apparatus 100 included eight emitter-receiver pairs 112a-112h. FIG. 6 shows the orientation of the receiver pairs into two lines of four. The lines are provided on perpendicular axes to provide cross-sectional information about the material flowing through the passageway 30.

If the two lines of emitter-receiver pairs are located in the same plane, it is preferred that the microprocessor poll each emitter-receiver pair in turn. However, by displacing one of the lines relative to the other, so that the two lines then lie in parallel planes spaced from each other, the microprocessor 118 can then poll one emitter-receiver pair from each of the lines simultaneously.

Since the material is travelling past the emitter-receivers and the receivers are polled in turn, it is possible to build up a three-dimensional representation of the flow of the material, enabling a more accurate determination of the amount of material passing through the passageway.

In this embodiment, if the microprocessor 118 establishes that the average power level received by one of the sensors 116a-116h is decreasing, the microprocessor 118 maintains the transmit power at the same level, but lowers the threshold value used to determine whether a particular signal level is a hit or a miss. If the threshold value is lowered to a predetermined level, the controller 100 indicates a blockage warning on the display (not shown).

It should be appreciated that the scope of this invention is not limited to the particular embodiments described above.

1. An apparatus for monitoring a particulate material, comprising;
a plurality of emitter-receiver pairs arranged in a spaced apart manner;
control means and associated memory, arranged to activate each emitter-receiver pair in sequence and obtain a signal from the receiver in that pair only, to keep in said associated memory a cumulative count of the signals from each receiver, and calculate from the cumulative counts an estimated total quantity of material passing between the emitter-receiver pair.

2. An apparatus as claimed in claim 1, wherein said control means is further arranged to compare the signal received from each receiver with a threshold value, to determine whether the signal represents a hit or a miss.

3. An apparatus as claimed in claim 2, wherein said control means keeps a cumulative count of signals representing hits from each receiver.

4. An apparatus is claimed in claim 2, wherein said control means keeps a cumulative count of signals representing misses from each receiver.

5. An apparatus as claimed in claim 2, wherein said control means is arranged to indicate a fault condition for an emitter-receiver pair if the signals from said receiver generate more than a predetermined number of consecutive misses.

6. An apparatus as claimed in claim 5, said control means is arranged to disregard the cumulative count for an emitter-receiver pair in calculating an estimated total quantity of material passing between the emitter-receivor pairs if a fault condition is indicated for that emitter-receiver pair, said control means being arranged to calculate the estimated total quantity of material from the cumulative counts of the remaining emitter-receiver pairs.

7. An apparatus as claimed In claim 1, wherein said control means stores in said associated memory calibration information including a relative weighting of each emitter-receiver pair and a conversion ratio of hits or misses to a quantity of material, said control means utilising the calibration information when calculating the estimated total quantity of material from the cumulative counts.

8. An apparatus as claimed in claim 1, wherein said control means stores in said associated memory characterisation data relating to the material flowing through the passageway, the control means arranged to be responsive to the characterisation information, the signals received from the emitter-receiver pairs and the cumulative counts to calculate an estimated total quantity of material flowing through the passageway.

9. An apparatus as claimed in claim 1, wherein said control means performs an analog to digital conversion of the signal from each emitter-receiver pair and stores said digital conversion in said associated memory, said control means further arranged to analyze said stored digital conversions to determine whether there has been an average decrease in the signal strength, and to lower said threshold value not the average decrease in the signal strength exceeds a predetermined value.

10. An apparatus as claimed in claim 9, wherein said control means is arranged to indicate a blockage warning if the threshold value is lowered to a prescribed value.

11. An apparatus as claimed in claim 1, wherein said control means performs an analog to digital conversion of the signal from each emitter-receiver pair and stores said digital conversion in said associated memory, said control means further arranged to analyse said stored digital conversions to determine whether there has boon an average decrease in the signal strength, and to increase the power to said emitters if the average decrease in the signal strength exceeds a predetermined value.

12. An apparatus as claimed in claim 11, wherein said control means is arranged to indicate a blockage warning if the power to the emitters is increased to a prescribed value.

13. An apparatus as claimed in claim 1, wherein the emitter-receiver pairs are provided about a passageway so as to monitor material passing through said passageway.

14. An apparatus as claimed in claim 13, wherein the apparatus is provided in a housing having openings for the emitters or receivers. The housing including a panel formed of a material transparent to the signal produced by the emittors, the panel protruding from a face of the housing by an amount corresponding to a wall thickness of the passageway to produce a substantially smooth inner surface in the passageway.

15. An apparatus as claimed in claim 14, wherein the housing includes at least one channel arranged to receive permanent magnets therein to secure the housing to the passageway wall.

16. An apparatus as claimed in claim 13, wherein the emitter-receiver pairs are arranged in two substantially perpendicular lines.

17. An apparatus as claimed in claim 16, wherein the lines are spaced apart so as to lie in two parallel planes.
